(19) United States
(12) Patent Application Publication
(10) Pub. No.: US 2012/0326946 A1
(43) Pub. Date: Dec. 27, 2012

(54) Three dimensional imaging system

(75) Inventors: Chang Yuan, Vancouver, WA (US); Dean Messing, Camas, WA (US); Xinyu Xu, Vancouver, WA (US)

(73) Assignee: Sharp Laboratories of America, Inc., Camas, WA (US)

(21) Appl. No.: 13/135,096

(22) Filed: Jun. 23, 2011

(51) Int. Cl. G09G 5/00

(52) U.S. Cl. 345/1.3

(57) ABSTRACT

A display system comprising first and second panels, where the second panel is maintained at a different orientation with respect to the first panel such that the first panel is non-coplanar with the second panel. The display system projecting the image onto the first and second display panels in such a manner so as to reduce geometric distortions of a viewer when viewing the image.

### CROSS-REFERENCE TO RELATED APPLICATIONS

None.

### BACKGROUND OF THE INVENTION

The present invention relates generally to a system for rendering an image on multiple non-planar displays.

There is a large amount of two-dimensional and three-dimensional content available suitable for display on multiple monitors. In many cases, displaying the content across multiple monitors provides a desirable viewing experience. For example, a desktop computer may be interconnected to a plurality of monitors, with the image being displayed across the multiple monitors. In some cases, the displays may be arranged in a semi-circular arrangement so that the image content provides a more encompassing experience in front of the viewer. Unfortunately, depending on the image content, the resulting viewing experience is less than desirable because the image lacks a natural perspective view.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a multi-pane display system.

FIG. 2 illustrates an embodiment of a 2D image mapped to 3D planar surfaces.

FIG. 3 illustrates an embodiment of a 2D image mapped to a 3D cylindrical surface.

FIG. 4 illustrates an embodiment of a 2D image mapped to a 3D spherical surface.

FIG. 5 illustrates an embodiment of a 2D image mapped to 3D planar and cylindrical surfaces.

FIG. 6 illustrates multiple depth layers mapped onto surfaces.

FIG. 7 illustrates a technique for single-viewpoint rendering of 2D images on multiple panels.

FIG. 8 illustrates an embodiment of single viewpoint rendering of 3D scenes.

FIG. 9 illustrates a technique for single-viewpoint rendering of 3D scene on noon-planar panels.

FIG. 10 illustrates a top view of a display camera configuration.

FIG. 11 illustrates a frontal view of a display camera configuration.

FIG. 12 illustrates a generalized technique for perspective projection.

FIG. 13 illustrates identified corners of a panel.

FIG. 14 illustrates determined vectors of a panel.

FIG. 15 illustrates on-axis projection.

FIG. 16 illustrates off-axis projection.

FIG. 17 illustrates frustum extents.

FIG. 18 illustrates vectors from the eye position to the screen corners.

FIG. 19 illustrates an embodiment of a multiple viewpoint rendering of 3D scenes.

FIG. 20 illustrates graphically single viewpoint rendering.

FIG. 21 illustrates graphically multiple viewpoint rendering.

FIG. 22 illustrates rendering with an enlarged zone of projection.

FIG. 23 illustrates a technique for multiple viewpoint rendering of a 3D scene on non-planar panels.

FIG. 24 illustrates a technique using multiple virtual cameras for multiple viewpoint rendering.

FIG. 25 illustrates a technique using multiple virtual cameras to generate images for multiple panels.

FIG. 26 illustrates an adjustment of 3D scene rendering for multiple virtual cameras.

### DETAILED DESCRIPTION OF PREFERRED EMBODIMENT

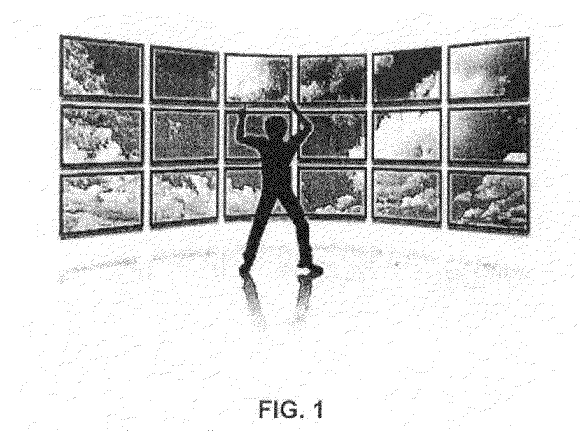

Referring to FIG. 1, a tiled display system includes a plurality of flat display panels. Each of the flat display panels are preferably arranged in a non-planar orientation where the flat display panels are maintained in a fixed orientation with respect to one another. The angular relationships between the panels are preferably maintained in a known relationship with respect to one another. In addition, the system preferably includes a calibration screen that permits the identification of the properties of each panel, and their orientation with respect to one another. The plurality of panels results in a display system that is larger than an individual panel, and also permits the orientation of the panels to be arranged to provide more three dimensional realism. Based upon the location of the viewer, the geometric configuration of the panels may result in different geometric distortions. In addition, the different orientations of the panels results in different geometric distortions, even for the same location of the viewer. Accordingly, the display system should preferably modify the two-dimensional and/or three dimensional image content in a suitable manner for presentation on the plurality of flat panel displays in a manner that reduces the geometric distortion. In many situations, there are multiple viewers viewing the same content from different locations. In such situations with multiple viewers, it is desirable to modify the two-dimensional and/or three dimensional content in a suitable manner for presentation on the plurality of flat panel displays that reduces the geometric distortion for each, while not as optimal for each.

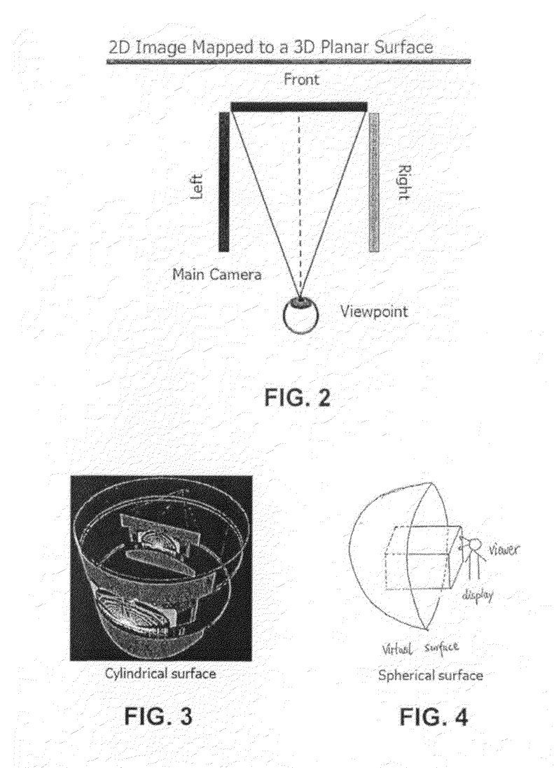

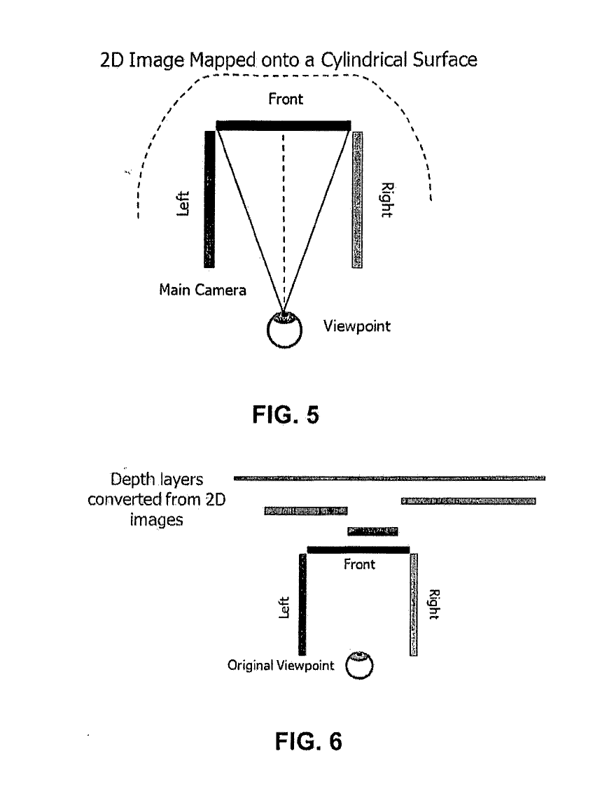

Referring to FIG. 2, the rendering of a two dimensional image on a plurality of panels may be based upon the viewer's viewpoint with respect to the panels. Referring to FIG. 3, the two dimensional image may be mapped onto a cylindrical surface. Referring to FIG. 4, the two dimensional image may be mapped onto a spherical surface. Referring to FIG. 5, the two dimensional image may be mapped onto a combination of planar surface and a cylindrical surface. Referring to FIG. 6, the two dimensional image may be converted to form a plurality of two dimensional images each of which having a different “depth”. The different depth layers may be manually labeled by the viewer and/or determined using automatic image segmentation techniques. The different two dimensional depth images may be mapped to a surface, such as that illustrated in FIG. 2, FIG. 3, FIG. 4, FIG. 5 and/or FIG. 6.

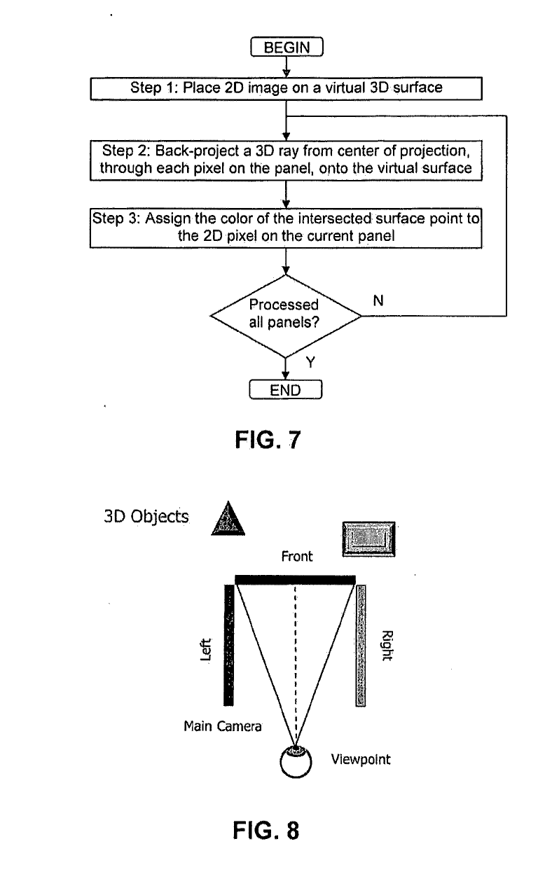

FIG. 7 illustrates a suitable technique for rendering two-dimensional images on a plurality of panels for a single viewer at a single viewpoint (or an estimated viewpoint) serving as a center of projection (COP). For each pixel on a panel, a ray may be extended from the COP, through the two-dimensional pixel, until the ray intersects with the virtual three dimensional surface. The color and/or luminance of the intersection point on the surface is sampled and assigned to the two-dimensional pixel. The process may thus be a sequential combination of inverse-projection and perspective projections. This process may be repeated for all of the panels of the display system.

Referring to FIG. 8, multiple three dimensional objects may be located virtually behind the panels, which may be arranged in any suitable arrangement. The rendering technique may be suitable to reduce the distortion of the objects rendered on the panels at a COP, even though the combination of panels are not planar.

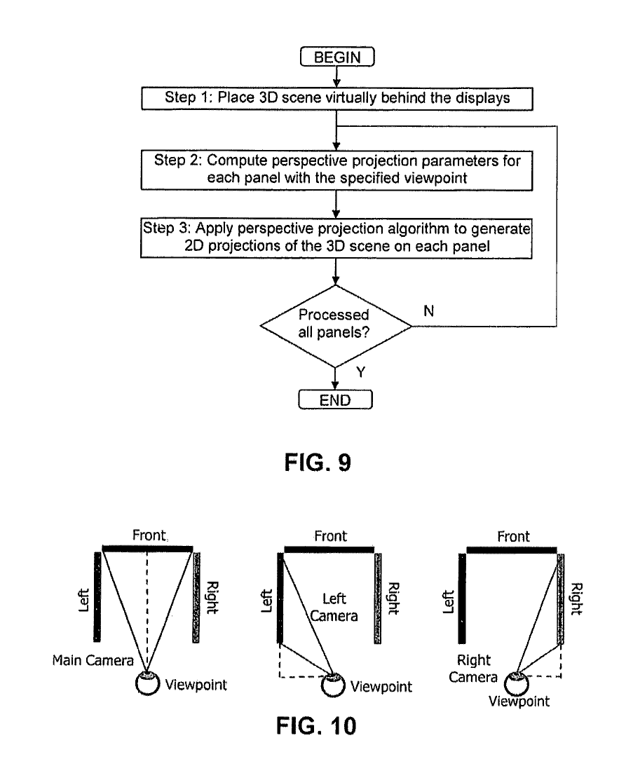

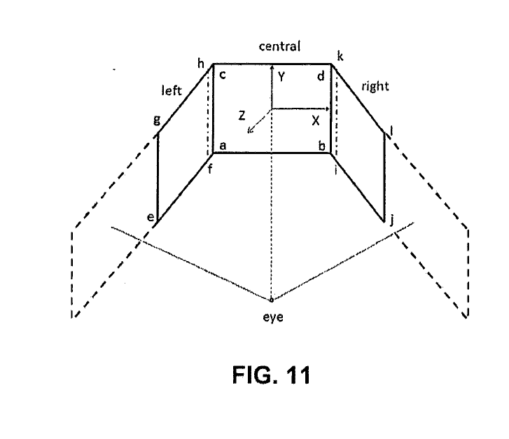

FIG. 9 illustrates a suitable technique for rendering three dimensional images on a plurality of panels for a single viewer at a single viewpoint serving as a center of projection. Perspective projection parameters may be computed for each panel based on their geometric configuration. The viewpoint for each panel may be located at the same location, namely the center of projection. To render the three dimensional scenes with more suitable geometry for each of the panels, a virtual camera for each panel may be used to project the three dimensional scene onto the panel with perspective projection, one for each display. The optical center of each camera may be located at the same position as the eye position. The optical axis of each camera may be perpendicular to the plane of its corresponding display. The view looking down on this configuration from above is illustrated in FIG. 10, and the frontal view of this display camera confirmation is illustrated in FIG. 11. This process may be repeated for all of the panels of the display system.

Given the width of the display, the height of the display, the original three dimensional coordinate system, the eye position, then the three dimensional coordinates of the corners of each panel may be determined. Otherwise the three dimensional coordinates of the corners of each panel may be provided. With the corners of each panel determined or otherwise provided, the eye position, the near and far projection planes, a perspective projection matrix may be computed. With the three dimensional scene and the perspective projection parameters, a three dimensional perspective projection technique may be used to determine two dimensional images for the panels which are projections of the three dimensional scene from the specified viewpoint.

Referring again to FIG. 11, for purposes of illustration and without loss of generality, the display system may include, one left display, one central display, and one right display. The angle between the left/right display and the central display may be denoted by θ, where θ is ≧90 degrees. To display a single coherent virtual environment, all of the display may define their projections in a common coordinate system. The coordinate system may be defined as follows. Define the origin at the center of the central display. The XY-plane may be aligned with the central display, the X axis points to the right, the Y-axis points to the left, and the positive Z-axis points to the viewer. The positions of the corners of the panels may be defined, such as being measured, determined, and/or provided. The eye position may be located at (0, 0, Z_{eye}) where Z_{eye} ensures that the eye can see all the displays.

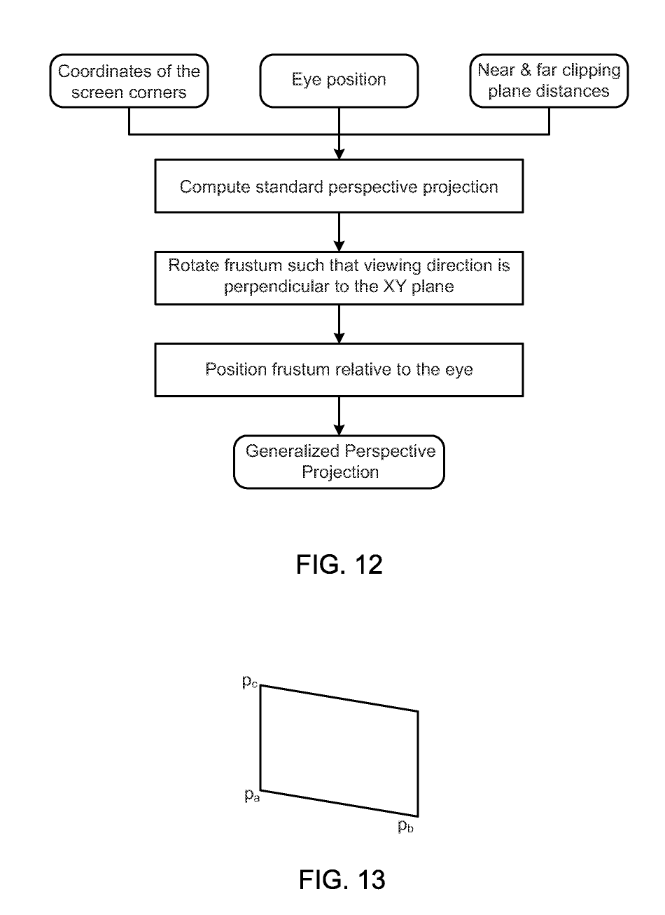

The user may move within the space and is not required to remain centered upon any of the screens. Because the display wraps around the user, at least in part, the screens may not lie in the XY plane. Referring to FIG. 12, a more generalized perspective projection is illustrated.

The standard perspective projection may be determined separately for each screen-eye pair (or each eye). By way of example, referring to the left panel of FIG. 11, the perspective projection may be determined based upon an assumption that the eye is looking perpendicular to the display. This frustum is then rotated afterwards such that the screen is non-perpendicular to the viewing direction.

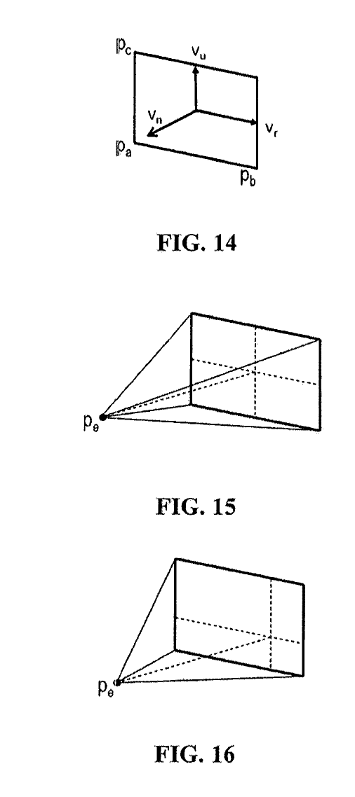

Referring to FIG. 13, the panel characteristics include screen corners pₐ at the lower left, p_{b} at the lower right, and p_{c} at the upper left. These values are used to encode the size of the screen, its aspect ratio, its position, and/or it orientation. Referring to FIG. 14, these locations may be used to determinate an orthornormal basis for the screen space. In screen space, the system may refer to these basis vectors as vᵣ, the vector toward the right, vᵤ, the vector pointing up, and vₙ, the vector normal to the screen (pointing directly out of it).

As the standard axes x, y, and z define an orthonormal basis for describing points relative to the origin of 3D Cartesian space, the screen-local axes vᵣ, and vₙ define a basis for describing points relative to the screen. These screen-local axes may be computed as follows:

$${v}_{r} = \frac{{p}_{b} - {p}_{a}}{‖ {p}_{b} - {p}_{a} ‖}$$

$${v}_{u} = \frac{{p}_{c} - {p}_{a}}{‖ {p}_{c} - {p}_{a} ‖}$$

$${v}_{n} = \frac{{v}_{r} \times {v}_{u}}{‖ {v}_{r} \times {v}_{u} ‖}$$

There are two primary types of perspective projection, namely, on-axis projection and off-axis projection.

Referring to FIG. 15, the on-axis projection may include an eye pₐ centered on the screen. The line from the eye drawn perpendicular to the screen along vₙ strikes the screen directly in the middle. One may refer that point of intersection as the screen-space origin. This coincides with the origin of the screen-space vector basis depicted above. Also in this configuration, the pyramid-shaped viewing frustum having the screen as its base and the eye as its apex is perfectly symmetric.

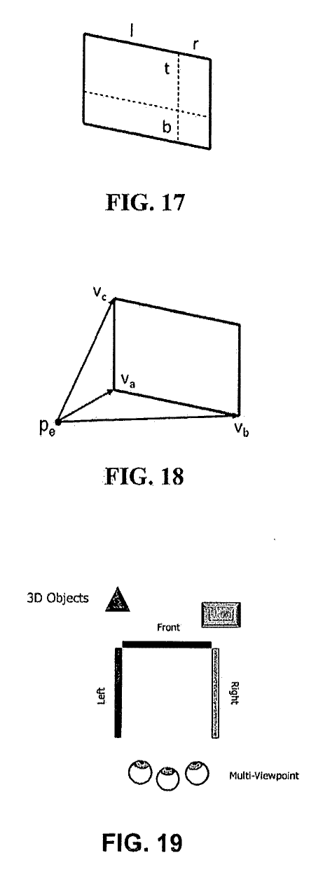

Referring to FIG. 16, the off-axis projection where the eye position is moved away from the center of the panel, results in the frustum being no longer symmetric, and the line from the eye drawn along vₙ no longer strikes the panel in the middle. Thus, when the viewer moves the screen-space origin moves with him. A projections may be based upon, the left frustum extent, the right frustum extent, the bottom frustum extent, the top frustum extent, and distances to the near and far clipping planes. These values may be referred to as l, r, b, t, n, and f respectively. The first four frustum values may be understood as distances from the screen-space origin to the respective edges of the screen, as shown in FIG. 17. As illustrated in FIG. 17, l and b are negative numbers, while r and t are positive numbers, in this embodiment. If the user moves far to the side of the screen, then the screen space origin may not fall within the screen at all, and any of these variables may be positive or negative.

The frustum extents are computed for use in computing the perspective projection. One technique for computing the frustum extents based upon screen corner positions and eye position. Referring to FIG. 18 as an intermediate step, the system may first compute vectors from the eye position pₑ to the screen corners. These vectors may be computed as follows.

vₐ=pₐ−pₑv_{b}=p_{b}−pₑv=p_{c}−pₐ

In particular, let d be the distance from the eye position pₑ to the screen-space origin. This is also the length of the shortest path from the eye to the plane of the screen. The system computes this value by taking the dot product of the screen normal with any of the screen vectors. Because these vectors point in opposite directions, the value may be negated, namely

d=−(vₙ□vₐ).

Given this, frustum extents may be computed. Take the frustum right extent r for example. When one takes the dot product of the unit vector vᵣ (which points from the screen origin toward the right) with the non-unit vector v_{b} (which points from the eye to the right-most point on the screen) the result is a scalar value indicating how far to the right of the screen origin the right-most point on the screen is.

Because frustum extents are specified at the near plane, it is desirable to scale this distance back from its value at the screen, d units away, to its value at the near clipping plane, n units away:

l=(vᵣ□vₐ)n/d

r=(vᵣ□v_{b})n/d

b=(vᵤ□v_{b})n/d

t=(vᵤ□v_{c})n/d

These values may be used in a 3D perspective projection matrix, defined as follows:

$$P = [ \begin{matrix}\frac{2 n}{r - l} & 0 & \frac{r + l}{r - l} & 0 \\ 0 & \frac{2 n}{t - b} & \frac{t + b}{t - b} & 0 \\ 0 & 0 & - \frac{f + n}{f - n} & - \frac{2 fn}{f - n} \\ 0 & 0 & - 1 & 0\end{matrix} ]$$

Note that the near and far clipping plane distance, n and f, may be specified based on the distances from the eye position not origin.

As defined above, the result is a frustum for an arbitrary screen viewed by an arbitrary eye, while the base of that frustum lies in the XY plane. Some graphical projection techniques only work when the view position is at the origin, looking down the negative Z axis, with the view plane aligned with the XY plane. To facilitate use of such a graphical project technique and/or use a different graphical projection technique, two additional determinations may be made, such as, first rotating the screen to align with the XY plane, and second correctly positioning it relative to the user.

The rotation of the screen to align with the XY plane may be performed by defining a 4×4 linear transformation matrix M using the screen space basis vectors vᵣ, vᵤ, and vₙ as columns:

$$M = [ \begin{matrix}{v}_{rx} & {v}_{ux} & {v}_{nx} & 0 \\ {v}_{ry} & {v}_{uy} & {v}_{ny} & 0 \\ {v}_{rz} & {v}_{uz} & {v}_{nz} & 0 \\ 0 & 0 & 0 & 1\end{matrix} ]$$

This is a transformation matrix for screen-local coordinates. It maps the Cartesian coordinate system onto the screen space coordinate system, transforming the standard axes x, y, and z into the basis vectors vᵣ, vᵤ, and vₙ. If something is lying in the XY plane, then this transformation matrix M will realign it to lie in the plane of the screen.

However, this is the opposite of what is often desirable. It is preferable to have something lying in the plane of the screen realigned to lie in the XY plane, so that the system may apply the a perspective projection to it. Hence instead it is preferable to have the following mapping:

$$M = [ \begin{matrix}{v}_{rx} & {v}_{ry} & {v}_{rz} & 0 \\ {v}_{ux} & {v}_{uy} & {v}_{uz} & 0 \\ {v}_{nx} & {v}_{ny} & {v}_{nz} & 0 \\ 0 & 0 & 0 & 1\end{matrix} ]$$

Then one multiplies the perspective projection matrix P by this M to rotate the frustum to align with XY plane. Now the system has a perspective projection which relaxes the projection plane alignment.

So far the obtained perspective projection is still referenced to the origin. Next the frustum may be modified to position the apex at the eye-position. This may be achieved by translating the eye position to the apex of the frustum. The apex of the perspective frustum is at zero, hence it may be translated along the vector from the eye. This can be accomplished by applying a transformation matrix, such as for example:

$$T = [ \begin{matrix}1 & 0 & 0 & - {p}_{ex} \\ 0 & 1 & 0 & - {p}_{ey} \\ 0 & 0 & 1 & - {p}_{ez} \\ 0 & 0 & 0 & 1\end{matrix} ]$$

These three matrices may be composed into a single projection matrix, P′=PMT.

Beginning with constant screen corners pₐ, p_{b}, p_{c}, eye position pₑ (varying by eye-tracking), and near and far clipping plane distances, a projection matrix is suitable for flexible configurations. An arbitrary number of arbitrarily-oriented screens may be defined together in a common coordinate system, and the resulting projection matrices present these disjointed screens as a single, coherent view in a virtual environment.

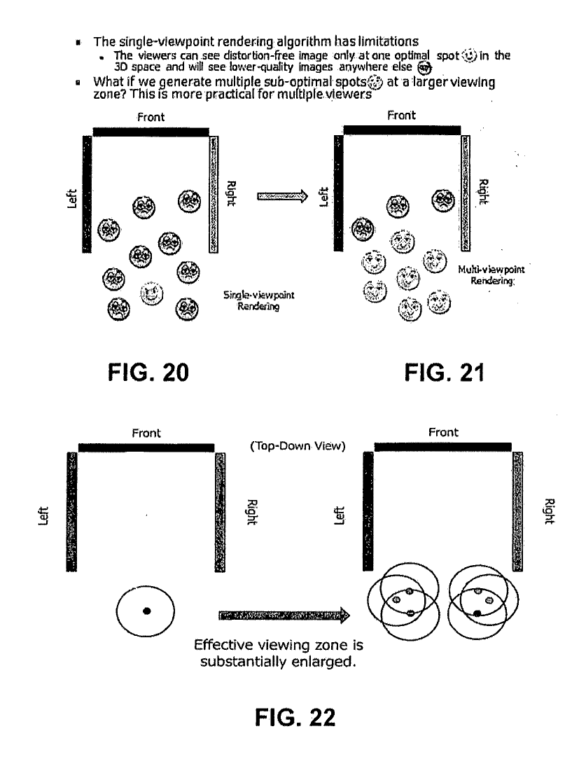

Referring to FIG. 19, multiple three dimensional objects may be located virtually behind the panels, which may be arranged in any suitable arrangement. The rendering technique reduces the distortion of the objects rendered on the panels at a COP, even though the combination of panels are not planar. In addition, the rendering technique may be modified in a suitable manner to accommodate multiple simultaneous viewpoints by rendering images toward multiple centers of projection. The resulting images, while not typically as good as they would appear to a single viewer at a single viewpoint, will be visually acceptable with otherwise reduced distortion. FIG. 20 and FIG. 21 illustrates graphically the resulting visual experience by using a multiple viewpoint rendering technique. Referring to FIG. 22, the result of the multiple viewpoint rendering technique may be an enlarged suitable viewing zone. Thus, the each panel (e.g., the entire panel) may be rendered to multiple viewpoints. The resulting renderings are combined in some manner to determine the values for each of the pixels of each of the displays.

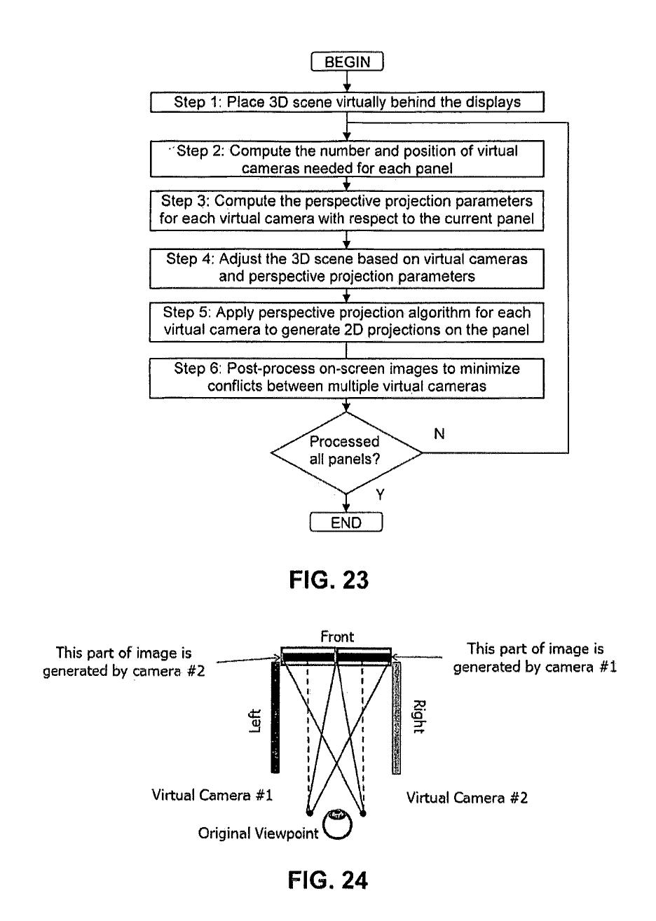

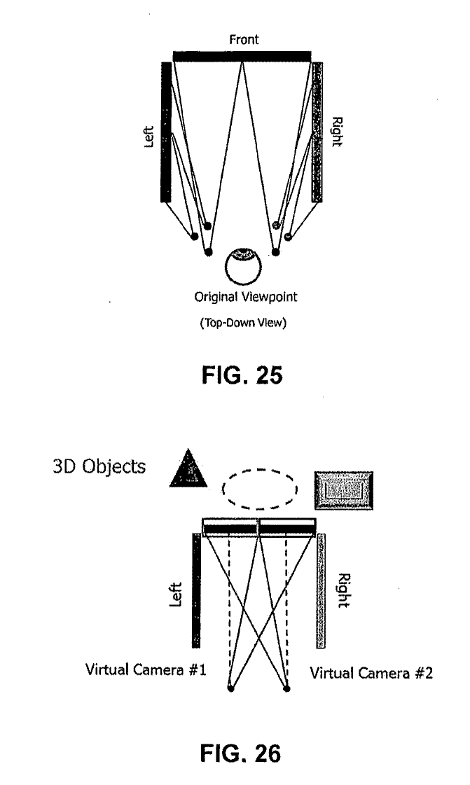

Referring to FIG. 23, a technique for multiple viewpoint rendering of a three dimensional scene for non-planar panels is illustrated with multiple enlarged COPs. The first, third, and fifth steps may be performed in a manner similar to the two dimensional image embodiments, if desired. The number of virtual cameras and their positions may be computed based on the number of viewers and their positions, or otherwise selected in any manner. In one embodiment, one virtual camera may be defined for each viewer and each panel. For example, if there are two viewers, two virtual cameras are defined for the front panel as illustrated in FIG. 24 The two cameras cover different parts of the three dimensional scene and have overlapping portions. The two dimensional image on the front panel may be generated by applying perspective projection towards these two virtual cameras, respectively. Thus, the entire image may be divided into multiple sub-images, where each panel is sub-divided into a plurality of regions, which are then adjusted based upon the viewer's positions. For example, the virtual camera #1 may correspond to the right half of the front panel, while the virtual camera #2 may correspond to the left half of the front panel. In this manner, the angled observation of the display for a viewer is rendered in a more accurate manner for the respective viewer. As illustrated in FIG. 25, two virtual cameras may also be defined for portions of the left panel and portions of the right panel, resulting in a total of six virtual cameras. The entire images on the three panels are then generated based upon these six cameras separately, with overlapping areas.

As multiple virtual cameras are used to render images on the same panel, there may be conflicts between the sub-images, especially along the border region between them. This is due to the fact that the sub-images are rendered based upon different center of projections and the visual perception is affected by their difference. Step four and six tend to reduce this conflict. At step four, the three dimensional objects in the scene may be slightly adjusted such that they do not lie in the overlapped regions of the two cameras. This can effectively reduce the conflicts between the virtual cameras. FIG. 26 illustrates an example of re-organizing the three dimensional scene to reduce the conflict zone (as indicated by the dotted circle).

Step six applies post processing to the generated two dimensional images in order to reduce and smooth out the conflicts between different views. In one embodiment, a blending technique may be applied to mix the two adjacent images together and form a smoother and more uniform view of the three dimensional scene. In particular, the image blending step may also use the three dimensional geometry to increase the correctness of the rendered shapes, e.g., straight lines and circles with correct aspect ratios.

Another embodiment of step six is to use multiple virtual cameras to generate the entire images from different viewpoints and apply an image warping technique to generate intermediate views. The image warping step may be implemented by decomposing the image into multiple triangular regions and then warping each triangle into an intermediate location, similar to an image morphing technique. This warping step may reduce the conflicts between the overlapped regions and generate a new view with smooth shape variations across the whole image. The warped image may have some degree of geometric distortion. The distortion, however, is reduced by the image warping process.

In many situations for rendering, it is sufficient to specify the field of view such as the near and far clipping plane distances, together with an implicit assumption that the viewer is directly in front of the display, facing perpendicular to the display, and looking in the center of the display to achieve sufficient rendering. However, often such specifications are inappropriate for a non-planar set of panels.

To reduce such limitations, it is desirable to permit a generalized perspective projection. A generalized perspective projection permits the viewing direction to be non-perpendicular to the projection plane, permits the viewing point on the display to be at any point in the screen instead of being restricted to the center, and/or permits the projection frustum to be rooted at any point. With the 3D coordinates of the corners of the projection screen, the 3D coordinates of the eye position, and the near and far clipping plane distances, then generalized perspective projection may be computed more efficiently. One manner of efficient computation is first computing the perspective frustum assuming the eye is looking perpendicularly to the screen, then rotating the viewing frustum such that something lying in the plane of the screen is realigned to lie in the XY plane; and next positioning the frustum relative to the user by moving the viewing frustum from origin to the eye position. The perspective frustum may be computed from the frustum extents (top, bottom, left and right) which are further computed given the coordinates of the corners of the screen.

In many cases, a perspective projection technique may be suitable for rendering the images. In other cases, such as extreme wide displays, it may be more desirable to incorporate a non-perspective projection technique as applied to a single viewpoint, multiple viewpoint and/or split display techniques.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A display system comprising:
(a) a first panel;
(b) a second panel maintained at a different orientation with respect to said first panel such that said first panel is non-coplanar with said second panel;
(c) said display system projecting said image onto said first and second display panels in such a manner so as to reduce geometric distortions of a viewer when viewing said image.

2. The display of claim 1 wherein said first panel is a flat panel.

3. The display of claim 2 wherein said second panel is a flat panel.

4. The display of claim 3 wherein said first panel and said second panel are at an angle greater than or equal to ninety degrees with respect to one another.

5. The display of claim 4 wherein said image is a two-dimensional image.

6. The display of claim 4 wherein said image is a three-dimensional image.

7. The display of claim 5 wherein said three-dimensional image is modified prior to said projecting.

8. The display of claim 1 wherein said projection is based upon a viewpoint at the center for each panel.

9. The display of claim 1 wherein said projection is based upon a separate projection for each panel.

10. The display of claim 1 wherein said projection is based upon a viewpoint not at the center for each panel.

11. The display of claim 1 wherein said projection is based upon a plurality of projections for each panel.

12. The display of claim 11 wherein each of said projections is based upon a different viewpoint.

13. The display of claim 5 wherein a plurality of depths are defined of said two-dimensional image.

14. The display of claim 1 wherein said projections use a common coordinate system.

15. The display of claim 14 wherein said projection based upon the viewer looking perpendicular to respective ones of said panel.

16. The display of claim 15 wherein said projection is based upon a frustum rotation.

17. The display of claim 16 wherein said frustum rotation results in a non-perpendicular viewing direction.

18. The display of claim 16 wherein said projection is based upon an on-axis projection.

19. The display of claim 16 wherein said projection is based upon an off-axis projection.

20. The display of claim 16 wherein said frustum is non-symmetric.

21. The display of claim 1 wherein said projection of claim 1 is based upon a plurality of spaced apart viewpoints.

22. The display of claim 21 wherein said projections are based upon a plurality of projections for each panel.
